(19) United States
(12) Patent Application Publication
(10) Pub. No.: US 2013/0249539 A1
(43) Pub. Date: Sep. 26, 2013

(54) Detection of a Metal or Magnetic Object

(71) Applicants: Tobias Zibold, Stuttgart (DE); Andrej Albrecht, Stuttgart (DE)

(72) Inventors: Tobias Zibold, Stuttgart (DE); Andrej Albrecht, Stuttgart (DE)

(73) Assignee: Robert Bosch GmbH, Stuttgart (DE)

(21) Appl. No.: 13/696,348

(22) PCT Filed: Mar. 9, 2011
(86) PCT No.: PCT/EP2011/053509

§ 371 Date: Feb. 20, 2013

(30) Foreign Application Priority Data
May 7, 2010 (DE) 102010028722.9

(51) Int. Cl. G01N 27/02

(52) U.S. Cl. CPC G01N 27/023
USPC 324/228

(57) ABSTRACT

A measuring device for detecting a metal object includes an emission coil configured to produce a magnetic field and a compensation network which is connected to the emission coil. A differential voltage is applied between the emission coil and the compensation network. The measuring device also includes a control device configured to supply the emission coil and the compensation network with alternating voltages such that the value of an alternating voltage component of the differential voltage, which is time synchronized with the alternating voltage, is minimized. The control device is configured to detect the metal object when a ratio of the alternating voltages does not correspond to a ratio of the flows flowing through the emission coils and the compensation network.

In certain types of machining workpieces, there is the risk that an object hidden in the workpiece will be damaged by the machining. When drilling into a wall, for example, a water, power or gas line running within the wall can be damaged. In the reverse case, it may be desirable to carry out the machining precisely in such a manner that an object hidden in the workpiece is also machined, for example if the hole from the above example is to run through a reinforcement iron or a bearing construction within the wall.

### PRIOR ART

In the prior art, coil-based metal detectors are known for detecting such a hidden object. Such detectors generate a magnetic field within an area to be measured. If there is a metallic object in the area to be measured, the object is detected due to its influence on the magnetic field generated. Frequently, at least two receiving coils are used for determining the magnetic field generated which are oriented and connected to one another in such a manner that in the absence of a metallic object in the area to be measured, the measurement signal supplied by both receiving coils goes to zero (differential measurement). In one variant, a number of transmitting coils are used for generating the magnetic field which are driven in such a manner that the signal measured in the two receiving coils goes to zero independently of a presence of a metallic object in the area to be measured (field-compensated measurement).

DE 10 2007 053 881 A1 describes a measuring method for determining the position or the angle of a coil with respect to two other coils. For this purpose, an alternating magnetic field is generated by means of two transmitting coils arranged at an angle to one another. A receiving coil is brought into the alternating magnetic field and the drive of the transmitting coils is changed in such a manner that the same voltage is induced in the receiving coil by each of the transmitting coils. A ratio of current values supplied by the transmitting coils is used as a measure for a determination of the position and/or angle of the receiving coil with respect to the transmitting coils.

DE 10 2004 047 189 A1 describes a metal detector having printed coils.

The invention is based on the object of providing a simple and accurate detector for a metallic object. A further object of the invention consists in specifying a method for determining the metallic object.

### DISCLOSURE OF THE INVENTION

The invention achieves these objects by means of a measuring device having the features of claim 1 and of a method having the features of claim 7. Subclaims specify preferred embodiments.

According to the invention, a measuring device for detecting a metallic object comprises a transmitting coil for generating a magnetic field and a compensation network connected to the transmitting coil, wherein a differential voltage is applied at the connection of the transmitting coil with the compensation network. A control device is provided for supplying the transmitting coil and the compensation network with alternating voltages in such a manner that the value of an alternating voltage component, synchronized in timing with the alternating voltage, of the differential voltage is minimized. The control device is configured for detecting the metallic object when the ratio of the alternating voltages does not correspond to the ratio of the currents flowing through the transmitting coil and the compensation network.

The metallic object can thus be reliably detected with the aid of only a single transmitting coil. The alternating voltages which are present at the transmitting coil and at the compensation network are thus always controlled in such a manner that the voltages dropped across the transmitting coil and the compensation network correspond to one another even when impedances of the transmitting coil and of the compensation network are not equal. The control signal is interpreted as the actual measurement signal.

The alternating voltages are preferably alternating voltages for changing the magnetic fields of the transmitting coils periodically in magnitude and phase. The alternating voltages provide for synchronous demodulation by which means interfering signals having frequencies not equal to the modulation frequency can be very effectively suppressed. In addition, alternating magnetic fields can be generated by the alternating voltages in order to induce eddy currents in nonmagnetic materials such as, e.g., copper due to which currents these can then be detected.

The compensation network can comprise at least one complex impedance. The impedances of the transmitting coil and of the compensation network can be equal and interfering influences such as temperature and aging effects can affect the transmitting coil and the compensation network in the same way so that an influence of the interfering influences is compensated for overall. The measuring device can then be calibrated once as part of the production of the measuring device and further calibration by a user can be dispensed with.

A connection can be provided between the transmitting coil and the compensation network, the control device being configured for controlling the voltage supply in dependence on a differential voltage present at the connection. Thus, a voltage pointing to a ratio of currents flowing through the transmitting coil and through the compensation network can be easily and precisely determined.

The compensation network can have a variable impedance. By this means, a sensitivity of the measuring device can be controllable. The impedance can be discretely or continuously variable and performed especially in dependence on the measurement signal. The compensation network can also be magnetically shielded.

According to a further aspect of the invention, a method for detecting a metallic object comprises the steps of supplying a transmitting coil and a compensation network connected to the transmitting coil with alternating voltages, of determining a differential voltage present at the connection of the transmitting coil with the compensation network, wherein the supplying of the transmitting coil and of the compensation network with alternating voltages is carried out in such a manner that the value of an alternating voltage component, synchronized in timing with the alternating voltages, of the differential voltage is minimized and of detecting the object when the ratio of the alternating voltages does not correspond to the ratio of the currents flowing through the transmitting coil and the compensation network.

The invention can also be designed as a computer program product, wherein a computer program product according to the invention comprises program code means for performing the method described and can run on a processing device or be stored on a computer-readable data medium.

### BRIEF DESCRIPTION OF THE FIGURES

In the text which follows, the invention will be described in greater detail with reference to the attached figures, in which:

FIG. 1 shows a block diagram of a measuring device;

FIG. 2 shows a detailed view of the measuring device from FIG. 1;

FIG. 3 shows an arrangement of a number of transmitting coils for the measuring device from FIG. 1; and

FIG. 4 shows a flowchart of a method for the measuring device from FIG. 1.

### DETAILED DESCRIPTION OF EXEMPLARY EMBODIMENTS

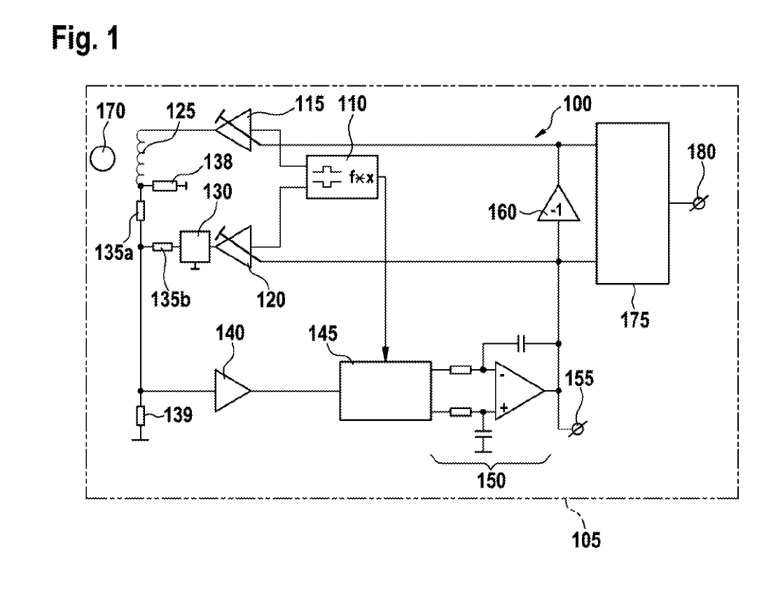

FIG. 1 shows a block diagram of a measuring device 100. The measuring device 100 is a part of a metal detector 105 for detecting metallic objects, for example of ferrous material.

A clock generator 110 has two outputs at which it provides phase-shifted periodic alternating signals, preferably phase-shifted by 180°. The alternating signals can comprise in particular rectangular, triangular or sinusoidal signals. The outputs of the clock generator are connected to a first controllable amplifier 115 and to a second controllable amplifier 120, respectively. Each of the controllable amplifiers 115, 120 has a control input via which it receives a signal which controls a gain factor of the controllable amplifier 115, 120. One output of the first controllable amplifier 115 is connected to a transmitting coil 125 and one output of the second controllable amplifier 120 is connected to a compensation network 130. The compensation network 130 provides an impedance which is within the range of that of the transmitting coil 125. In some embodiments, the compensation network 130 can have a variable impedance.

In the text which follows, an embodiment is described in which the impedances of the transmitting coil 125 and of the compensation network 130 correspond to one another. However, this is generally not required for the operation of the measuring device 100.

A second terminal of the transmitting coil 125 is connected to a shunt resistor 138 leading to ground and to a resistor 135a leading to an input amplifier 140. The compensation network 130 has a ground terminal and is connected to the input amplifier 140 via a resistor 135b. The voltage dropped across the shunt resistor 138 is proportional to the current flowing through the transmitting coil 125. The currents flowing via the resistors 135a and 135b produce a total current via a third resistor 139 to ground. This current is proportional to the sum of the voltage dropped across the shunt resistor 138 and of the voltage dropped in the compensation network 130. The voltage dropped across the resistor 139 to ground is thus proportional to the sum of the voltage dropped across the shunt resistor 138 and the voltage dropped in the compensation network 130. This is present at the input of the input amplifier 140.

The output of the input amplifier 140 is connected to a synchronous demodulator 145. The synchronous demodulator 145 is also connected to the clock generator 110 and receives from it a clock signal which points to the phase angle of the signals provided at the outputs of the clock generator 110. In a simple embodiment in which the signals provided by the clock generator 110 are symmetric rectangular signals, one of the output signals can be used as clock signal. The synchronous demodulator 145 essentially switches the signal received from the input amplifier 140 alternatingly through at its top and lower output, respectively, on the basis of the clock signal provided by the clock generator 110.

The two outputs of the synchronous demodulator 145 are connected to an integrator (integrating comparator) 150 which is represented here as an operational amplifier provided with two resistors and two capacitors. Other embodiments are also possible, for example as active low-pass filter. A digital embodiment of the integrator 150 following the synchronous demodulator 145 is also conceivable in which the signal at the output of the synchronous demodulator 145 is analog/digital converted at one or several times within a halfwave and is then compared with the corresponding value from the next halfwave. The difference is integrated and, e.g. changed again into an analog signal and used for controlling the amplifier.

Whilst the synchronous demodulator 145 provides the measurement signal received by the input amplifier 140 at the lower of its outputs, the integrator 150 integrates this signal over time and provides the result at its output. Whilst the synchronous demodulator 145 provides the measurement signal received from the input amplifier 140 at its upper output, it is integrated inverted over time by the integrator 150 and the result is provided at the output of the integrator 150. The voltage at the output of the integrator 150 is the integral of the difference of the low-pass-filtered outputs of the synchronous demodulator 145.

The signal provided by the integrator 150 is provided for further processing via a terminal 155. In addition, a microcomputer 175 can be connected to the control inputs of the controllable amplifiers 115, 120. The microcomputer 175 compares the provided signal with a threshold value and outputs at an output 180 a signal which points to the metallic object. The signal can be offered visually and/or audibly to a user of the metal detector 105.

In addition, the microcomputer 175 can carry out further processing of the signals picked up from the control inputs of the controllable amplifiers 115, 120 and, in dependence on these, control parameters of the measuring device 100. For example, a frequency or signal shape of the alternating voltages at the outputs of the clock generator 110 can be varied or a sensitivity of the receiving amplifier 140 can be changed. In a further embodiment, other ones of the elements shown of the measuring device 100 are implemented by the microcomputer 175, for instance the clock generator 110, the synchronous demodulator 145 or the integrator 150.

The same signal of the integrator 150 is also used for controlling the gain factors of the controllable amplifiers 115 and 120, the second controllable amplifier 120 being connected directly to the output of the integrator 150 and the first controllable amplifier 115 being connected to the output of the integrator 150 by means of an inverter 160. The inverter 160 inverts the signal provided to it in such a manner that the gain factor of the first controllable amplifier 115 increases in dependence on the output signal of the integrator 150 to the same extent to which the gain factor of the second controllable amplifier 120 decreases, or conversely, respectively. It is also conceivable that only the gain factor of one of the two controllable amplifiers 115, 120 is controlled whilst the gain factor of the second controllable amplifier 115, 120 is kept at a fixed value.

If there is no metallic object 170 in the area of the magnetic field generated by the transmitting coil 125, the impedances of the transmitting coil 125 and of the compensation network 130 are equally large and a voltage of zero is present between the resistors 135a and 135b. If necessary, the measuring device 100 must be calibrated for this condition before a metallic object 170 is brought within range of the transmitting coil 125.

If the metallic object 170 is within range of the transmitting coil 125, this changes the impedance of the transmitting coil 125 and thus the current flowing through the transmitting coil 125. Correspondingly, the alternating voltage component, which is synchronized in timing, of the voltage present between resistors 135a, 135b is not equal to zero and the signal present at the output of the integrator 150 changes by an amount with respect to zero. The controllable amplifiers 115 and 120 are thereupon changed inversely in their gain factors in such a manner that the voltages which are present at the transmitting coil 125 and at the compensation network 130 are changed in such a manner that the alternating voltage component, which is synchronized in timing, of the voltage present between resistors 135a and 135b is reduced back to zero. The presence of the metallic object 170 can be detected by comparing the output voltage of the integrator 150 with zero.

In the case of different impedances of the transmitting coil 125 and of the compensation network 130, the signal output at terminal 155 is not zero but another predetermined value in the case where there is no object. The comparison of the control value as described above then takes place with respect to the predetermined value. A determination of the predetermined value can be determined in the context of a calibration in that the signal at terminal 155 is determined in absence of the metallic object.

The compensation network 130 is advantageously designed in such a manner, if possible, that it is subject to temperature and aging effects which correspond to those of the transmitting coil 125 in order to, by influencing the elements 125, 130 in the same sense, compensate for an influence on the measuring device 100 by temperature and aging overall. In this case, a calibration of the measuring device 100 can be performed once during the production of the measuring device 100 and does not need to be repeated by a user contemporaneously with a measurement to be performed.

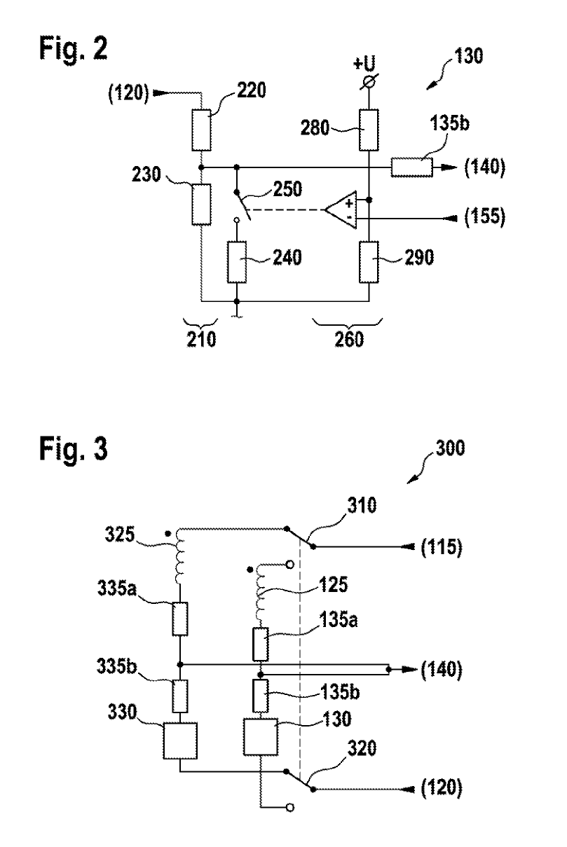

FIG. 2 shows an expanded representation of the compensation network 130. In a simple embodiment, the compensation network 130 only comprises a complex voltage divider 210 which comprises complex impedances 220 and 230. The complex impedances 220, 230 are selected in such a manner that, together, they form an impedance which corresponds to the impedance of the transmitting coil 125 when there is no metallic object to be detected in the area of the magnetic field generated by the transmitting coil 125. The voltage, divided to ground by means of impedances 220 and 230, of the second controllable amplifier 120 is coupled out by means of the second resistor 135b and conducted to the input amplifier 140 as is described above with reference to FIG. 1.

In a further embodiment of the compensation network 130, yet another complex impedance 240 is provided which can be connected in parallel with the complex impedance 230 by means of a switch 250. By operating the switch 250, it is possible to switch between two different impedances of the compensation network 130. Correspondingly, further impedances can also be achieved by connecting yet other and/or further complex impedances like the complex impedance 240 in parallel or in series.

In an exemplary implementation, the switch 250 is driven by a threshold switch 260 which comprises a comparator (operational amplifier) 270 and two resistors 280 and 290. The resistors 280 and 290 form a voltage divider between a supply voltage U of the measuring device 100 and ground. The divided voltage is connected to a non-inverting input of the comparator 270. An inverting input of the comparator 270 is connected to the output of the integrator 150 or terminal 155, respectively. If the voltage provided by the integrator 150 exceeds the voltage provided by the voltage divider 280, 290, the comparator 270 operates the switch 250 and, by doing so, changes the impedance of the compensation network 130.

FIG. 3 shows an arrangement 300 having a number of pairs of transmitting coils and compensation networks for the measuring device 100 from FIG. 1. In addition to the arrangement described with reference to FIG. 1, of the transmitting coil 125 and the compensation network 130 with the resistors 135a, 135b, a further transmitting coil 325 and a further compensation network 230 having further resistors 335a, 335b are provided in corresponding interconnection. Resistors leading from one of the terminals of the transmitting coils 125, 325 to ground corresponding to the shunt resistor 138 in FIG. 1 are not shown. The resistor 139 from FIG. 1, connected to the input amplifier 140, is also not shown in FIG. 3. The coils 125 and 325 can be constructed as printed circuits (“printed coils”) on a circuit board. Other elements of the measuring device 100 can also be arranged on the same circuit board.

Two switches 310 and 320 coupled to one another in each case selectively connect terminals of the transmitting coil 125 and of the compensation network 130 or of the transmitting coil 325 and of the compensation network 330 to the outputs of the controllable amplifier 115, 120 from FIG. 1. The connections between resistors 135a, 135b, 335a and 335b, corresponding to one another, are connected to one another and lead to the input amplifier 140.

In a further embodiment, only one compensation network 130 is provided which is interconnected with various transmitting coils 125, 325. In this case, the switch 320 selectively connects the terminal not connected to the compensation network 130 of the second resistor 135b to one of the first resistors 135a, 335a. Elements 335b and 330 are omitted.

If the differential voltage at the input amplifier 140 changes when the switches 115 and 120 are switched over, it is possible, on the basis of the geometric arrangement of the coils 125, 325, to infer a direction in which the metallic object 210 is located, for example by triangulation. Similarly, it is conceivable to infer a distance of the metallic object. The determination of direction can be refined by further transmitting coils. If a large number of transmitting coils arranged sufficiently close to one another is used, a resolution of the measuring device 100 can be increased up into a pictorial domain.

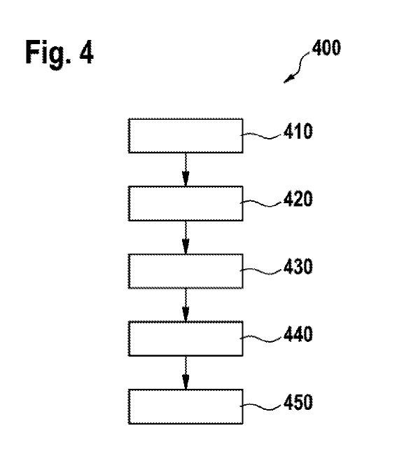

FIG. 4 shows a diagrammatic flowchart of a method 400 for detecting a metallic object 210 corresponding to the measuring device 100 from FIGS. 1 and 2. In a step 410, the transmitting coil 125 and the compensation network 130 are in each case supplied with alternating voltages, the voltages being phase-shifted with respect to one another, preferably phase-shifted by 180°.

In a subsequent step 420, a differential voltage is determined which appears at the resistors 135a and 135b and which points to a ratio of a current flowing through the transmitting coil 325 with respect to a current flowing through the compensation network 330. Subsequently, the differential voltage is demodulated synchronously with a phase of the alternating voltages in a step 430 and the result is integrated.

In a step 440, the controllable amplifiers 115 and 120 are driven inversely on the basis of the integrated result until the alternating voltage component, synchronized in timing, of the differential signal has approached zero again.

Finally, it is compared in a step 450 whether the integrated result deviates from zero by more than a predetermined amount and in this case the metallic object 170 is detected. Optionally, a visual and/or audible reference to the metallic object 170 can be output to a user.

1. A measuring device for detecting a metallic object comprising:
a transmitting coil configured to generate a magnetic field;
a compensation network connected to the transmitting coil, wherein a differential voltage is applied at a connection between the transmitting coil and the compensation network; and
a control device configured to supply the transmitting coil and the compensation network with alternating voltages such that a value of an alternating voltage component, synchronized in timing with the alternating voltages, of the differential voltage is minimized, wherein the control device is configured to detect the metallic object when a ratio of the alternating voltages does not correspond to a ratio of currents flowing through the transmitting coil and the compensation network.

2. The measuring device as claimed in claim 1, wherein the alternating voltages are phase-shifted with respect to one another to change the magnetic field of the transmitting coil periodically in magnitude and phase.

3. The measuring device as claimed in claim 1, wherein the compensation network comprises at least one complex impedance.

4. The measuring device as claimed in claim 1, wherein the compensation network has a variable impedance.

5. The measuring device as claimed in claim 4, wherein the impedance is varied in steps.

6. The measuring device as claimed in claim 5, wherein the control device is configured to control the impedance in dependence on a difference of the alternating voltages.

7. A method for detecting a metallic object, comprising:
supplying a transmitting coil and a compensation network connected to the transmitting coil with alternating voltages;
determining a differential voltage applied at a connection between the transmitting coil and the compensation network wherein the supplying of the transmitting coil and of the compensation network with alternating voltages is carried out such that a value of an alternating voltage component, synchronized in timing with the alternating voltages, of the differential voltage is minimized; and
detecting the metallic object when a ratio of the alternating voltages does not correspond to a ratio of currents flowing through the transmitting coil and the compensation network.

8. A computer program product having program code for performing a method when said computer program product runs on a processing device or is stored on a computer-readable data medium, the method comprising:
supplying a transmitting coil and a compensation network connected to the transmitting coil with alternating voltages;
determining a differential voltage applied at a connection between the transmitting coil and the compensation network wherein the supplying of the transmitting coil and of the compensation network with alternating voltages is carried out such that a value of an alternating voltage component, synchronized in timing with the alternating voltages, of the differential voltage is minimized; and
detecting the metallic object when a ratio of the alternating voltages does not correspond to a ratio of currents flowing through the transmitting coil and the compensation network.
